(19) United States
(12) Patent Application Publication
(10) Pub. No.: US 2018/0051541 A1
(43) Pub. Date: Feb. 22, 2018

(54) PERMEABLE PORT COVER SYSTEM AND METHOD

(71) Applicant: Packers Plus Energy Services Inc., Calgary (CA)

(72) Inventor: Daniel Jon THEMIG, Calgary (CA)

(21) Appl. No.: 15/677,021

(22) Filed: Aug. 15, 2017

Related U.S. Application Data
(60) Provisional application No. 62/378,086, filed on Aug. 22, 2016.

(51) Int. Cl. E21B 43/08; E21B 34/14; E21B 43/26; B01D 39/18

(52) U.S. Cl. CPC E21B 43/082; E21B 34/14; E21B 2034/007; B01D 39/18; E21B 43/26

(57) ABSTRACT

A port cover for a fluid port of ported sub with a tubular body having one or more fluid ports provided in the external wall of the tubular body. The port cover comprises: a permeable media shaped to snugly fit a void space formed by a fluid port of the fluid port in the external wall; and an adhesive adapted to fix the permeable media in the void space. The permeable media is adapted to permit migration of fluids therethrough for pressure equalization between an inner and an outer side of the external wall, and disallow migration of solid particles of a specified size in the sub through the fluid.

### RELATED APPLICATIONS

This Patent Application is based on Provisional Patent Application 62/378,086, filed Aug. 22, 2016, the content of which is hereby incorporated by reference in its entirety.

### FIELD

The specification is directed to a permeable port system and method for wellbore treatment.

BACKGROUND

Well treatment strings for staged well treatment operations typically carry tools to create a plurality of isolated zones within a well and allow selected fluidic access to each such isolated zone. For example, a treatment string may comprise a series of ported subs, each with one or more ports connecting the inner bore of the string to a subset of the well formation corresponding to an isolated zone, where each sub can be individually activated to allow stimulation fluids (e.g., acid, gelled acid, gelled water, gelled oil, CO₂, nitrogen and/or proppant laden fluids) or other fluids to be introduced through its ports to the well formation for the given isolated zone.

In cemented multi-stage operations, cement is used to support and anchor the treatment string and create isolated stages. Prior to cementing the treatment string in place, drilling mud and circulation fluid may be pumped down the string and into the wellbore to remove debris from the drilling operation. Cement is then pumped down the well filling the annulus between the treatment string and wellbore. The ports of the ported subs are then opened, using ball-drop actuated sliding sleeves for example, and stimulation fluid is introduced to fracture the cement and surrounding formation. When carrying out cemented operations in conventional ported subs with sliding sleeves however, mud, wellbore debris and cement tend to jam the subs such that they cannot be reliably opened.

FIG. 1a is a simplified diagram of a conventional ball-activated ported sub 100. Ported sub 100 comprises a tubular body defined by a wall 102 that defines an inner bore 104 extending from an upper end to a lower end. The term ‘upper’ and lower' are relative to the surface end of the wellbore. The tubular body has fluid ports 110 that connect the inner bore 104 with the outside of the sub 100. When the sub is inside a liner, the ports 110 provide fluidic access from inner bore 104 to the annulus around ported sub 100. A sleeve 120 is axially slidable from a port-closed position in which sleeve 120 covers the ports 110 as seen in FIG. 1a, to a port-open position in which sleeve 120 does not cover the ports 110, as seen in FIG. 1b. As also seen in the embodiment of FIG. 1b, the ports 110 may be opened a ball that displaces the sleeve to slide towards the lower end of the sub. Conventionally, the sub also has a solid port cover 124, typically made of rubber or plastic, which is placed over the ports in order to prevent mud, cement and debris from entering into the port when the ports are in the port-closed position. When sleeve 120 is in the port-closed position, void spaces 122 exist between the port cover 124 and sleeve 120.

In ball-drop cemented multi-stage operations, the sub 100 is typically run-in the wellbore with the ports closed, the port covers 124 being positioned over the ports to keep the void spaces 122 protected as drilling mud is circulated and cementing occurs. The port cover 124 is supposed to keep out particulates from the drilling mud, wellbore debris and cement, which otherwise would collect in void spaces 122 and work their way between outer wall 106 of the tubular body and sleeve 120 potentially jamming sleeve 120 closed. Cement may be particularly problematic because the cement may bond with the outer surface of sleeve 120 and outer wall 106, sealing sleeve 120 closed. The port covers 124, however, can be blown or warped into the void space 122 as the sub is run-in and situated inside the wellbore, because of the high pressure conditions in the wellbore. The port cover 124 may become so damaged, that cement, debris and drilling mud and part or parts of the port cover can invade the void space 122.

According to one known solution, some port covers and sleeves are coated with a material with which cement cannot bond, such as Teflon, to prevent the previously described unwanted cemented bonding with the sleeve and other sub components around the port. However, such coatings could be damaged during run-in and circulation of drilling mud and the sleeve may still be prone to jamming due to particulates entering between port cover 124 and sleeve 120.

Another solution has been to pack the void spaces 122 with silicone caulking prior to run-in, either with or without a port cover 124. However, the hydrostatic pressures in the wellbore can cave in the caulking and jam it into the crevices between the sleeve 120 and the wall 106 of the tubular body, thus compounding the aforementioned problems with cement, debris and mud, jamming up the operation of the sub. Instead of preventing jamming by protecting ports 110 from debris and cement, silicone caulking can actually contribute to the problem of ported subs becoming jammed.

Another problem caused by cement solid invading the void space 122 occurs when the ports are opened to begin fracking operations. The cement solid will dissipate the power of the stimulation fluid and can result in less effective fracking, and that can thus require the application of increased fracking pressure that may fall outside the pressure tolerances that were assumed to be in place when the fracking operation was being planned.

### SUMMARY

Before proceeding further, it should be noted that the terms “upper” and “lower” “are used to refer to a feature being on or closer to the well surface side (upwell side) relative to a corresponding feature that farther away from the well surface. For example, an “upper” end of a sleeve or sub generally refers to the end that is closer to well surface side than a corresponding “lower” end. A feature may be referred to as an “upper” feature relative to a “lower” feature even if the features are vertically aligned as may occur, for example, in a horizontal portion of a well.

As well, the specification uses the term “permeable” for a material that allows fluid flow through, but filters solids, i.e. a material that is permeable to fluids only.

Still further, term “void” or “void space” in this specification is used for the space formed between the outside surface of the sleeve and the outside surface of the tubular body of the sub.

According to one embodiment, a port cover for a fluid port of ported sub with a tubular body having one or more fluid ports provided in the external wall of the tubular body is proposed. The port cover comprises: a permeable media shaped to snugly fit a void space formed by a fluid port of the fluid port in the external wall; and an adhesive adapted to fix the permeable media in the void space, wherein the permeable media is adapted to, permit migration of fluids therethrough for pressure equalization between an inner and an outer side of the external wall, and disallow migration of solid particles of a specified size in the sub through the fluid port.

In accordance with one embodiment, the sub ports are covered with a permeable port cover prior to run-in. The permeable port cover, also referred to as a permeable port plug, should be preferably made of permeable media selected to have sufficient permeability so that fluid can flow through under pressure, but provide sufficient structure to prevent cement from setting up as a cement solid in the sub's port or to weaken cement that sets in the port. By allowing fluid into the permeable port cover, no pressure differential can build up between the void space and the space outside the sub, which reduces the occurrence of the cover being caved in and rendered useless as may happen when solid port covers or caulking is used.

Still further, this specification is directed to a wellbore tool comprising: a tubular body with an external wall; one or more fluid ports provided in the external wall; a sleeve adapted to move inside the tubular body from a port closing position to a port opening position; and a port cover of a permeable media shaped to snugly fit a void space formed by each respective fluid port of the one or more fluid ports and fixed within the void space, wherein the permeable media is adapted to, permit migration of fluids therethrough for pressure equalization between an inner and an outer side of the external wall, disallow migration of solid particles of a specified size between the sleeve and the external wall, and obstruct cement from setting up in the respective fluid port.

The permeable media is also selected to preferably filter out particles of a selected size. Accordingly, larger drill solids are not able to obstruct the ports. Furthermore, the permeable media can be selected such that, while some cement solids may penetrate the permeable media, there will be insufficient particulates for the cement to set up as a cement solid in the permeable media. Also, the permeable material is preferably selected to hold up under oil-based mud, be compatible with water and oil, stand temperatures between 250-300° C. Furthermore, the material does not have to be too tight on filtering; visible porous spaces are acceptable. For example, the permeable media may be a sponge-like material. Another consideration for selecting the permeable media is to allow for pressure equalization.

In some embodiments, a retaining member may be used to protect the permeable media while providing fluid filtration. A permeable tape may be wrapped around the body of the ported sub to hold the permeable port cover in place. In another embodiment, the port cover may be held in place by an external sleeve that is wrapped around the outer surface of the ported sub. A shrink wrap may also be used as the retaining member, the wrap being placed in an undercut zone provided in the outside diameter of the tubular body in the section of the body that includes the ports. The material of the shrink wrap could be perforated to allow fluid flow. Other embodiments of the retaining member cold be a neoprene sock around the outer diameter of the undercut, a wide footprint rubber band.

In other embodiments, a permeable port cover can have an outer frame. The outer frame may have sufficient elasticity so that the port cover can be snapped in place in the port. In another embodiment, the outer frame may be otherwise coupled to other components of the ported sub.

Embodiments described herein provide an advantage of substantially reducing jamming of the ported sub caused by debris, cement and drilling mud, using a superior technology over the use of conventional port covers, caulking, the application of coatings such as Teflon, and other known conventional techniques. Embodiments described herein provide another advantage because fractures may be initiated at a lower pressure. Thus, when cement solid is in the void space when the ports are opened as in conventional port coverings, the cement solid will dissipate the power of the stimulation fluid. On the other hand, if fluid is in port openings rather than cement when the ports open, there less force distribution of the stimulation fluid prior to reaching the formation is needed.

Preferably, the permeable port covers described herein are used with subs for wellbore fluid treatment operations. In some embodiments, port covers may be used in conjunction with cement diffusers, such as described in U.S. Pat. No. 7,798,226, “Cement Diffuser for Annulus Cementing,” issued Sep. 21, 2010 to Themig, which is hereby fully incorporated herein by reference.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Accordingly, the drawings and detailed description are to be regarded as illustrative in nature and not as restrictive.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIGS. 1a-1b depict one embodiment of a ported sub for performing operations in a wellbore.

FIGS. 2a-2c depict one embodiment of a ported sub for performing operations in a wellbore, the ported sub including a permeable port cover.

FIG. 3 is a diagrammatic representation of one embodiment of a permeable port cover.

FIG. 4 is a diagrammatic representation of one embodiment of a sheet of permeable media.

FIG. 5 is a diagrammatic representation of one embodiment of a tool for cutting permeable media.

FIG. 6 is a diagrammatic representation of one embodiment of installing a permeable port cover.

FIG. 7 is a diagrammatic representation of one embodiment of securing a permeable port cover.

FIG. 8 is a diagrammatic representation of one embodiment of a sleeve for retaining a permeable port cover.

FIG. 9 is a diagrammatic representation of another embodiment of a permeable port cover.

FIG. 10 is a diagrammatic representation of another embodiment of a permeable port cover.

FIG. 11 is a diagrammatic representation of another embodiment of a permeable port cover.

FIG. 12 is a diagrammatic representation of another embodiment of a permeable port cover which may be used with jet nozzles.

FIG. 13 is a cross-section of the jet nozzle with the permeable port cover shown in FIG. 12.

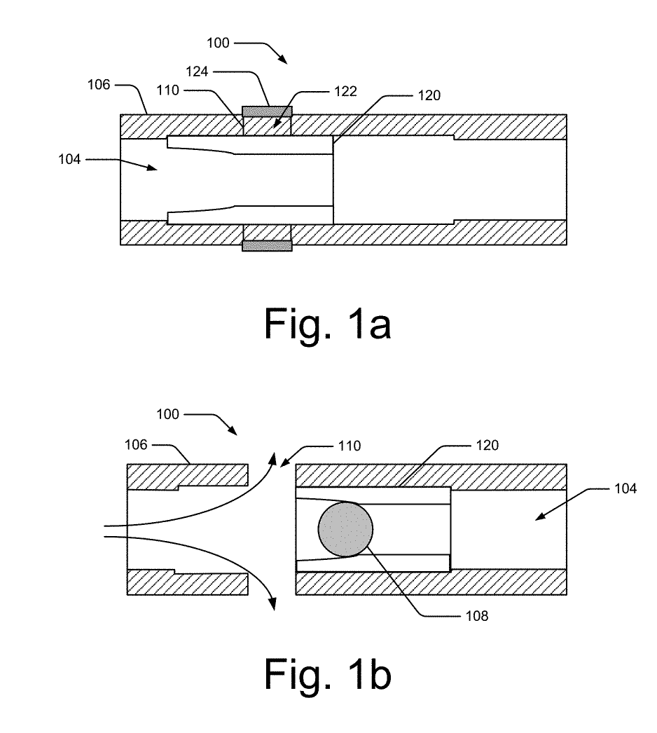

### DETAILED DESCRIPTION

This disclosure and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

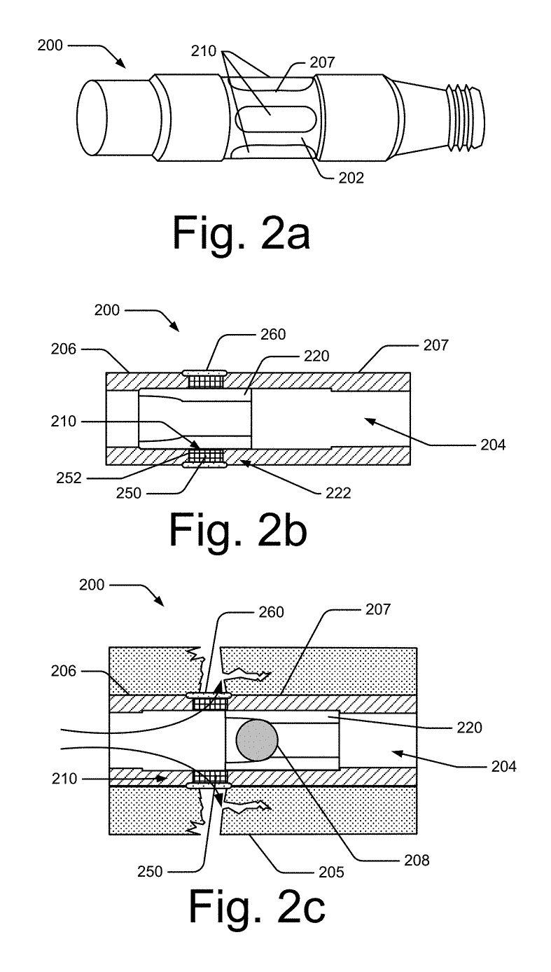

FIGS. 2a-2c, collectively referred to as FIGS. 2, are simplified diagrams of one embodiment of a ball-activated ported sub 200. FIG. 2a shows a spatial view of a ported sub 200, FIG. 2b illustrates a cross-sectional view of the ported sub 200 in a run-in configuration and FIG. 2c illustrates sub 200 in a well treatment configuration. Ported sub 200 has tubular body with a wall 206 and an inner bore 204, extending from an upper end to a lower end better seen in FIGS. 2b and 2c. As seen in FIG. 2a, wall 206 has a section 207 in which one or more ports 210 are built, to allow fluid passage between the inner bore 204 and the area outside the sub. Section 207 preferably has a turn-down outside diameter, as seen better in FIG. 2a, for accommodating the port covers 250, shown in FIGS. 2b and 2c. In the embodiments of FIGS. 2a-2c, a sleeve 220 is provided inside the inner bore 204 and is adapted to move between a port closing position shown in FIG. 2b and a port opening position, shown in FIG. 2c.

At run-in, as shown in FIG. 2b, permeable port covers 250 allow pressure to equalize in port 210, thus considerably impeding solids from entering between sleeve 220 and outer wall 206 of the sub, while promoting lower fracturing pressures compared to the absence of permeable port covers 250.

The tubular body can be formed from one or more tubular members and may be threaded into or otherwise joined with other tubulars in a tubing string. As indicated above, fluid ports 210, defined through the wall 206, provide access of the fluid from inner bore 204 to the outer surface 207 of the tubular body when opened, so that fluid can be injected into the annulus around the ported sub 200. In some cases, fluid ports 210 may be frac ports through which fracturing fluid is injected into the well.

Sleeve 220 is axially slidable from the port closing position in which sleeve 220 covers the ports 210 as seen in FIG. 2b, to the port fully open position in which sleeve 220 does not cover the ports 210 as shown in FIG. 2c. The sleeve has an outer surface denoted with 209 on FIG. 2b. While in the embodiment of FIG. 2c sleeve 220 is illustrated as a ball-activated sleeve, which slides downwards when actuated by a ball 208 launched surface. Sleeve 220 may be shifted using other mechanisms. For example, sleeve 220 may shift based on the concept of providing a piston face on the sliding sleeve such that raising tubing pressure will create a pressure differential sufficient to shift sleeve 220 to the port opening position. In another embodiment, sleeve 220 may be shifted using a shifting tool.

With reference to FIG. 2b, when sleeve 220 is in the port closing position, void spaces 222 are formed in the wall of the tubular body wall 226 and extend from the outer surface 209 of sliding sleeve to the outer surface 207 of the outer wall of ported sub 200. Permeable port covers 250 are installed in each port 210 to at least partially fill the corresponding void space 222. As indicated above, port covers 250 are configured to allow fluids, such as water, to flow into void spaces 222 when the ports are open, for example during run-in and fracking, but at the same time, they are adapted to filter out selected drill and cement solids that may clutter the ports. Port covers 250 help significantly reduce failures of ported sub 200 by deterring solids from entering the area between sliding sleeve 220 and outer wall 206 through the port 210. In addition, port covers 250 can weaken cement proximate to ports 210 by preventing cement from setting up in void spaces 222 or weakening the structure of cement that sets up in voids spaces 222. Therefore, the fracturing pressure may be reduced compared to ported sub without port covers 250.

In accordance with one embodiment, each port cover 250 includes one or more layers of permeable media selected to have sufficient permeability so that gases and liquids can pass through the media. The permeable media allows liquid and gas migration in both directions (into and out of the permeable media) to allow liquid and gas pressures in void space to equalize with respect to the space in the wellbore outside the ported sub 200, while ported sub 200 is run-in. The port cover 250 will therefore not blow out or be squeezed into the area between sleeve 220 and outer wall 206 by a differential pressure condition.

The permeable media can have a selected permeability from low permeability to a relatively high permeability. The selection of permeability can depend on the fluids the tool is expected to encounter as thicker drilling muds may have a tendency to plug up lower permeability port covers. The permeability can be selected to be high enough such that drilling fluids and other fluids in the wellbore do not plug up the permeable media.

According to one embodiment, the permeable material is selected to be permeable to liquids and gasses (e.g., to allow saturation by liquids) in drilling mud, circulation fluid or wet cement but impermeable to particles of greater that a selected size. That is, the permeable media can prevent larger drill and cement solids from entering the permeable material and hence the area between sliding sleeve 220 and outer wall 206 through the port 210. In some embodiments, the permeable media can be selected such that, while some cement solids may penetrate into the permeable media, there will be insufficient particulates for the cement to set up as a cement solid in void space 222. In other embodiments, the permeable media may have a cell structure or other structure that allows cement to set up. However, any cement that forms in the permeable media will be weak due to interference by the permeable media. Thus, while fluid and gas can pass into and through the permeable port covers 250 to equalize pressure between the void space and the outside of the sub, ingress of solids can be inhibited.

The permeable media may also be selected for organic chemical stability in oil, salt water, fresh water or other wellbore fluids and ability to maintain form and permeability at elevated temperatures.

The permeable media is preferably a foam with an open-cell structure. Solid foams are typically classified into open-cell-structured foams and closed-cell structured foams, based on their pore structure. Open-cell-structured foams contain pores that are connected to each other and form an interconnected network. The pores could fill with any gas that surrounds the foam. In the closed-cell foam-structures, the pores are not interconnected, resulting in a higher compressive strength. In accordance with one embodiment, the permeable media may be a porous material with an open cell structure in which interconnected pockets within the material permit the passage of gasses or liquids between the cells. The porous material, in some embodiments, may be an open cell or combined open cell and closed cell foam or sponge or sponge.

The permeable port covers 250 may be secured in ports 210 in a variety of manners. According to one embodiment, an adhesive can be used to join the side surfaces of port covers 250 to the surfaces 252 around void spaces 222. The permeable port covers 250 may also be held in place by a retaining member 260 that can allow liquid and gasses to flow into and out of the port covers 250. According to one embodiment, retaining member 260 comprises an external jacket sized to fit in outer diameter turn down area 202.

With reference to FIG. 2c, sliding sleeve 220 can be shifted, for example by actuating device 208, to open ports 210 to provide fluidic access from inner bore 204 to the annulus around ported sub 200, as shown by the arrows. According to the embodiment of FIG. 2c, which shows a cemented application, fracturing fluid may be used to fracture cement 205 and the surrounding formation. In some embodiments, permeable port covers 250 and retaining member 260 are configured as consumables that are terminally damaged during fracturing or other well treatment.

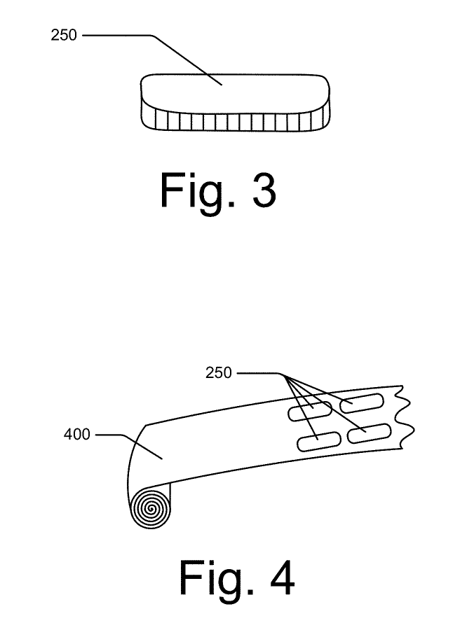

FIG. 3 is a diagrammatic representation of one embodiment of a permeable port cover 250. In the illustrated embodiment, permeable port cover 250 may be formed as a plug of permeable media shaped to match the shape of port 210. Adhesive may be applied to the side of permeable port cover 250 and the permeable port cover inserted into a port.

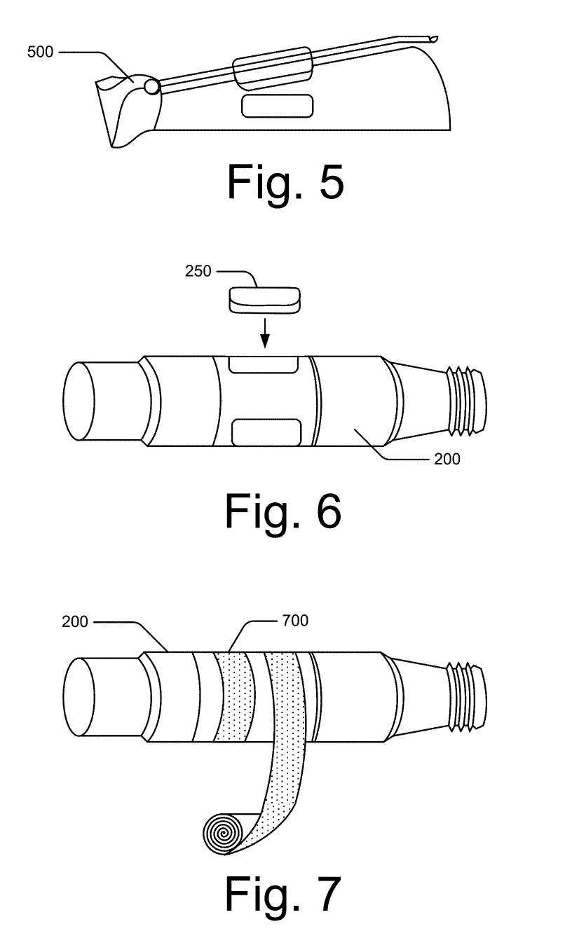

FIG. 4 is a diagrammatic representation of a sheet 400 of permeable media. Permeable port covers 250 may be cut from a sized or rolling sheet 400 of permeable media material. FIG. 5 is a diagrammatic representation of an embodiment of a stamping tool 500 for cutting permeable port covers from a sheet of permeable media.

FIGS. 6 and 7 illustrate one embodiment of installing permeable port covers 250 in the ports of the ported sub 200. According to one embodiment, an adhesive can be applied to the sides of the permeable port covers 250 and the permeable port covers 250 inserted into the ports 210 of ported sub 200. The adhesive may adhere the sides of port cover 250 to the surfaces of ports 210 (e.g., surfaces 252 of ports 210, shown in FIG. 2b). Retaining member 260 may be used to retain the port covers 250 in ports 210. In some embodiments, the retaining member may at least partially cover ports 210 to retain covers 250.

As discussed above, a permeable port cover may include one or more layers of permeable material. With reference to FIG. 7, the retaining member 260 comprises an external permeable or perforated tape 700 wrapped around ported sub 200 to hold port covers 250 in place.

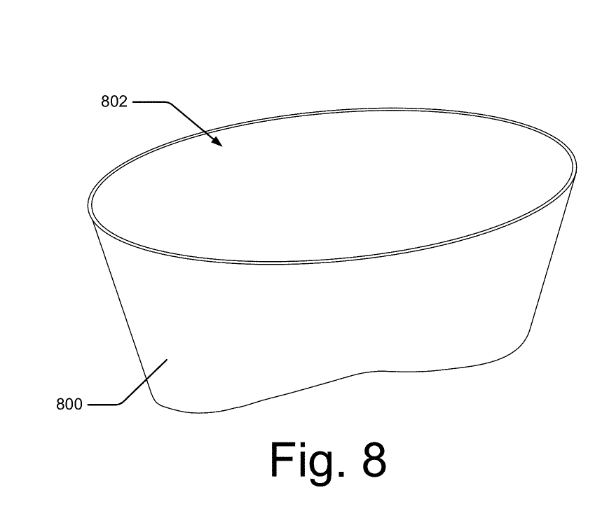

In another embodiment, the retaining member comprises an external permeable port cover 800 in the form of a jacket that is fitted over ported sub 200. FIG. 8 shows a diagrammatic representation of an external permeable port cover 800 that can be disposed over ports 210 to act as retaining member 260. The external permeable port cover 800 and a port cover 250 act together to form a permeable port cover for a port.

Permeable port cover 800 may be formed of a material that conforms to the outer surface of ported sub 200 including, but not limited to, neoprene, rubber tubing and shrink wrap material that would be placed over sponge. Permeable port cover 800 can be formed of a permeable or perforated material to allow liquid and gas flow into and out of inner permeable port covers 250. In addition, permeable port cover 800 can be formed to minimize pressure redistribution during fracking. According to one embodiment, permeable port cover 800 can include perforations or other features such that fracking fluid can easily burst through permeable port cover 800 at ports 210.

In another embodiment, a port cover with a permeable media can have an outer frame. The outer frame may have sufficient elasticity so that the port cover can be snapped in place in the port. In another embodiment, the outer frame may be otherwise coupled to other components of the ported sub.

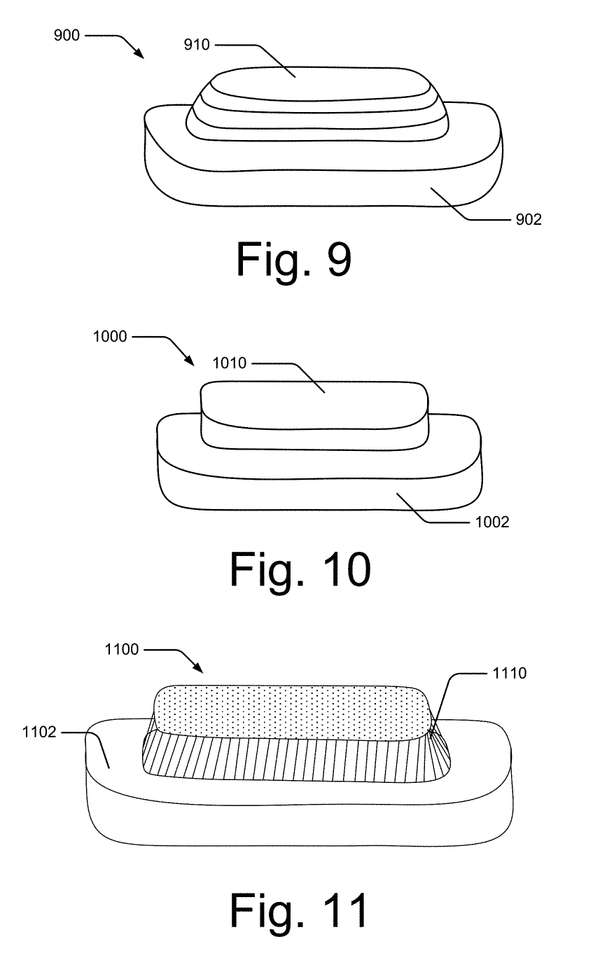

FIGS. 9 and 10 illustrate another embodiments of the port cover, denoted with 900 (FIGS. 9) and 1000 (FIG. 10. Port covers 900 and 1000 include a fitted section 902, 1002 that fits in a port, e.g., in a void space 222 of the port as shown in FIG. 2, and an extruding section 910, 1010 that interferes with cement around the port. Extruding section 910, 1010 may protrude past the outer surface 207 of ported sub 200 and may be selected, in some cases, to have a sufficient length to reach the rock formation. Fitted section 902, 1002 is formed of a permeable media as discussed above. Extruding section 910, 1010 may be formed from the same material or of a different material than fitted sections 902, 1010. In some embodiments, extruding section 910, 1010 may be formed from a material having a different permeability than fitted sections 902, 1002 and, in some cases, can be formed of a non-permeable material.

Extruding section 910 or 1010 interferes with cement formation to provide mechanical advantages. Thus, when port 210 is opened, the pressure forces work radially out in multiple directions from extruding section 910, 1010, promoting break down of the cement.

FIG. 11 illustrates another embodiment of a port cover 1100. Port cover 1100 includes a fitted section 1102 and an extruding section 1010. Fitted section 1102 is formed of a permeable media as discussed above. The permeable media can allow fluid and gas pressures to equalize while running in a tool and filter out drill and cement solids to promote smooth functioning of the tool. Extruding section 1110 can include brushes such as described in U.S. Pat. No. 7,798,226, “Cement Diffuser for Annulus Cementing,” issued Sep. 21, 2010 to Themig, which is hereby fully incorporated herein by reference. Extruding section 1110 are provided in order to interfere with cement around the port for better connection to the surrounding formation and lower breakdown pressures.

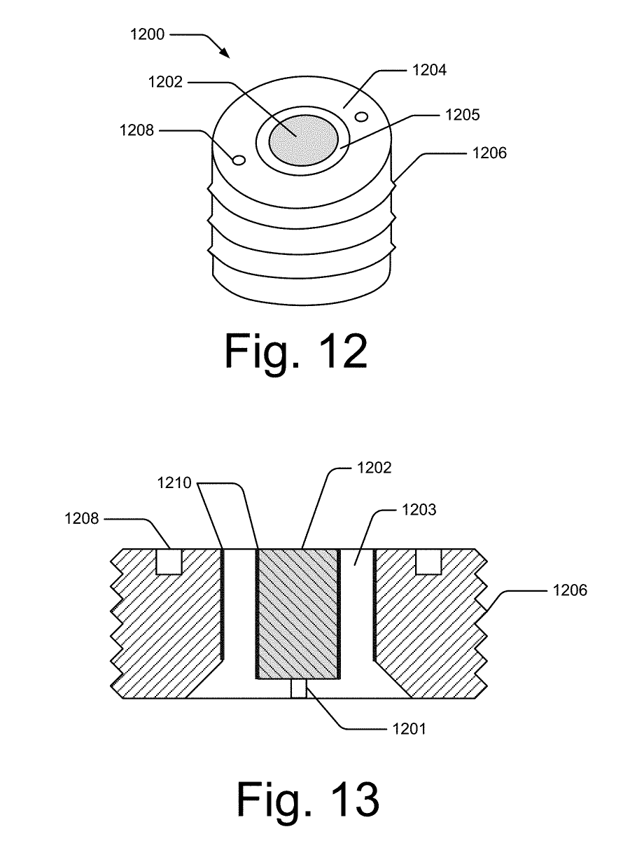

It can be noted that port covers may be used with ports having a variety of configurations. For example, port covers can be adapted to ports having various shapes. Moreover, permeable port covers may be used in ports formed through nozzles. FIGS. 12 and 13 illustrate one embodiment of a permeable port cover comprising a permeable media plug 1202 disposed in a nozzle 1200. The nozzle has preferably a hole 1201 of a ¼″ diameter, and an externally threaded tubular body 1204 with threads 1206 for attachment to a fluid port, such as port 210 of FIG. 2. Pressed-in brass member 1205 is placed in the inner bore of the tubular body and attached using adhesive 1210 or is just pressed in and locked tight to the wall of the inner bore of the body 1204. As better seen in FIG. 12, the permeable media plug 1202 is placed in a void space 1203 and is attached to the press-in brass 1205 with adhesive material shown at 1210. Reference number 1208 illustrates wrench holes enabling a wrench to screw the nozzle in the port.

Threaded nozzles either machined into or pressed into a pressed powder nozzle, as described in the US Patent Application 20090321145 (Fisher et al.) are preferred.

As in the previously described embodiments, fluid is allowed to pass through the permeable port plug 1202, while solids of a certain selected size are filtered out thus avoiding clogging of the nozzle head 1201.

The permeable port cover may further include an extruding section that extends out of the nozzle to interfere with cement.

A variety of permeable media may be used in port covers described herein. In some embodiments, the permeable media is formed from all non-petroleum materials. In accordance with one embodiment, the permeable media is inorganic foam, e.g. a cellulose sponge. Examples of cellulose sponges include but are not limited to cellulose sponges (small particle) available from Toray Fine Chemicals of Japan and 3M SDS F13 Cellulose Sponges from 3M Corporation of St. Paul, Minn., United States. In other embodiments, the permeable media may include organic foams.

In one implementation, the permeable retaining member 260 can be formed of a stretchable neoprene fabric, 1.5 mm thick or other desired thickness) with nylon fabric covering and perforations. By way of example, but not limitation, the neoprene fabric may be neoprene fabric available from Marco International of Irvine, California with an Airprene finish. The generally soft nature of neoprene in combination with the perforations provided by the Airprene finish is believed to prevent undue pressure distribution that would cause increased fracturing pressures.

A variety of suitable adhesives may also be used. By way of example, but not limitation, 3M-SCOTCH WELD-Weather Stripping and Gasket Adhesive 1300 from 3M Corporation of St. Paul, Minn., United States may be used to adhere permeable port cover 250 to ported sub 200. Another example adhesive is Permatex Super Weatherstrip Adhesive #81850 by Permatex of Hartford, Conn.

For the permeable jacket 800 of FIG. 8, a variety of suitable adhesives may also be used. For example 3M-SCOTCH WELD-Weather Stripping and Gasket Adhesive 1300 from 3M Corporation of St. Paul, Minn. or Permatex Super Weatherstrip Adhesive #81850 by Permatex of Hartford, Conn., may be applied to inner surface 802.

In some embodiments, the port covers may be coated with materials that further inhibit cement from setting up.

Furthermore, in some embodiments, the port covers can be formed of a material that degrades with temperature.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

What is claimed is:

1. A port cover for a fluid port of ported sub with a tubular body having one or more fluid ports provided in the external wall of the tubular body, the port cover comprising:
a permeable media shaped to snugly fit a void space formed by a fluid port of the fluid port in the external wall; and
an adhesive adapted to fix the permeable media in the void space, wherein the permeable media is adapted to,
permit migration of fluids therethrough for pressure equalization between an inner and an outer side of the external wall, and
disallow migration of solid particles of a specified size in the sub through the fluid port.

2. The port cover of claim 1, wherein the specified size is selected based on the operation to be performed by the ported sub and by the characteristics of the wellbore.

3. The port cover of claim 2, wherein the wellbore is a cemented wellbore.

4. The port cover of claim 2, wherein the operation to be performed is one of fracking and wellbore fluid treatment.

5. The port cover of claim 1, adapted to obstruct cement from setting up in the fluid port.

6. The port cover of claim 1 wherein the permeable media is formed from non-petroleum products.

7. The port cover of claim 1, wherein the permeable media is formed from a cellulose sponge material.

8. The port cover of claim 1, wherein the permeable media formed from a perforated material, the perforations having the specified size.

9. The port cover of claim 1, wherein the adhesive is provided on one of: an inner wall of the void space, a lateral surface of the port cover, or both.

10. The port cover of claim 1, further comprising a retaining member placed over the fluid port, for further retaining the permeable media into the void space.

11. The port cover of claim 10, wherein the retaining member comprises an external jacket wrapped over the one or more ports.

12. The port cover of claim 11, wherein material external jacket is made of one of: neoprene material, permeable fabric and a perforated material.

13. The port cover of claim 1, further comprising:
a nozzle including:
an externally threaded tubular body, for mounting inside the fluid port;
a tubular member fixed inside the tubular body, providing a cylindrical inner bore;
a nozzle head for forcing fluid under pressure out of the ported sub during a wellbore operation, the nozzle head opening in the inner bore,
wherein the permeable media is affixed in the inner bore.

14. The port cover of claim 13, wherein the tubular member is made of brass.

15. The port cover of claim 13, wherein the nozzle head is made of carbide.

16. A wellbore tool comprising:
a ported sub with
a tubular body with an external wall;
one or more fluid ports provided in the external wall;
a sleeve adapted to move inside the tubular body from a port closing position to a port opening position; and
a port cover of a permeable media shaped to snugly fit a void space formed by each respective fluid port of the one or more fluid ports and fixed within the void space
wherein the permeable media is adapted to,
permit migration of fluids therethrough for pressure equalization between an inner and an outer side of the external wall,
disallow migration of solid particles of a specified size between the sleeve and the external wall, and
obstruct cement from setting up in the respective fluid port.

17. The wellbore tool of claim 16, wherein the specified size is selected based on the operation to be performed by the ported sub and by the characteristics of the wellbore.

18. The wellbore tool pf claim 17, wherein the wellbore is a cemented wellbore.

19. The wellbore tool of claim 17, wherein the operation to be performed is one of fracking and wellbore fluid treatment.

20. The wellbore tool of claim 16, wherein the permeable media is formed from one of: non-petroleum products, a cellulose sponge material and a perforated material, the perforations having the specified size.
